(19) United States
(12) Patent Application Publication
(10) Pub. No.: US 2026/0298096 A1
(43) Pub. Date: Oct. 1, 2026

(54) ROTOR BLADE SYSTEM FOR A TURBINE ENGINE

(71) Applicant: General Electric Company, Schenectady, NY (US)

(72) Inventors: Cem Tutcu, Istanbul (TR); Keegan Mehrtens, Peabody, MA (US)

(21) Appl. No.: 19/097,268

(22) Filed: Apr. 1, 2025

(51) Int. Cl. F01D 5/16

(52) U.S. Cl. CPC F01D 5/16; F05D 2260/961

(57) ABSTRACT

A rotor blade system including a rotor, and a plurality of blades coupled to the rotor, the plurality of blades arranged in an airfoil distribution pattern, the airfoil distribution pattern including one or more baseline blades and one or more intentionally mistuned blades. The one or more intentionally mistuned blades have a span from a base to a tip of the one or more intentionally mistuned blades. The one or more intentionally mistuned blades includes a mistuning feature having a notch formed on a surface of the one or more intentionally mistuned blades and located at a vicinity of the tip to generate a vibration frequency difference between a vibration frequency of the one or more intentionally mistuned blades and a baseline natural vibration frequency of the one or more baseline blades.

### TECHNICAL FIELD

The present disclosure relates generally to rotor blades of turbine engines and, in particular, to frequency mistuned rotor blades in turbine engines and turbine engines using such blades.

### BACKGROUND

Turbine engines, such as gas turbine engines, generally include a fan and a turbo-engine. The fan includes fan blades.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic cross-sectional diagram of a turbine engine, according to an aspect of the present disclosure.

FIG. 2 is a schematic diagram of a front view of a rotor blade system having a rotor and a plurality of blades mounted thereon, according to an embodiment of the present disclosure.

FIGS. 3A through 3D show examples of patterns of the plurality of blades, according to embodiments of the present disclosure.

FIG. 4 is a schematic representation of a first intentionally mistuned blade, according to embodiments of the present disclosure.

FIG. 5 is a cross section of a mistuning feature, taken along line 5-5 shown in FIG. 4, according to an embodiment of the present disclosure.

FIG. 6 is a schematic representation of the first intentionally mistuned blade to show various dimensions of the mistuning feature and various dimensions of the first intentionally mistuned blade, according to an embodiment of the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first,” “second,” and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

As used herein, “flutter” is a self-excited vibration of a blade due to the interaction of structural-dynamic forces and aerodynamic forces.

As used herein, “flutter margin” is a measure, at a given flow rate, of a pressure ratio difference between an onset of flutter and an operating line of the blade.

As used herein, “loading shock” is a shockwave that is generated on the blade.

As used herein, the “natural frequency” of a blade is the frequency at which the blade vibrates or resonates.

As used herein, “mode shape” is a deformation that a blade would show when vibrating at a particular natural frequency of the blade.

As used herein, “mistune,” “mistuning,” and/or “mistuned” is a variation of a shape, a size, and/or a feature in a blade as compared to the shape, the size, and/or the features of another blade of a rotor. “Mistune,” “mistuning,” and/or “mistuned” includes altering or modifying the dynamic response to aerodynamic excitation relative to a baseline blade and/or to another intentionally mistuned blade present on the rotor with the first intentionally mistuned blade. The altered or modified dynamic response includes one or more of shift(s) or change(s) in natural frequenc(ies) and/or changes in mode shape(s) relative to the baseline blade or the other intentionally mistuned blade.

As used herein, “baseline” blades are blades that include a baseline shape, a baseline size, and/or baseline features. Baseline blades include baseline natural frequencies and/or baseline mode shapes. In this way, baseline blades are not intentionally mistuned and do not include an intentional mistuning feature.

As used herein, an “intentionally mistuned blade” is a blade designed and formed to be mistuned relative to a baseline blade and/or to another intentionally mistuned blade. For example, an intentionally mistuned blade is designed and formed to have an altered or modified dynamic response to aerodynamic excitation relative to its baseline blade and/or another intentionally mistuned blade present on the rotor with the intentionally mistuned blade. The altered or modified dynamic response includes one or more of shift(s) or change(s) in natural frequenc(ies) and/or changes in mode shape(s) relative to the baseline natural frequencies and/or baseline mode shapes of the baseline blade or the natural frequencies and/or the mode shapes of the other intentionally mistuned blade.

As used herein, an “intentional mistuning feature” is the shape, the size, and/or the features of an intentionally mistuned blade that is different than the baseline shape, the baseline size, and/or the baseline features of a baseline blade and/or the shape, the size, and/or the features of another intentionally mistuned blade that is formed and designed to shift or to change the natural frequencies and/or to shift or to change the mode shapes of the intentionally mistuned blade relative to the baseline natural frequencies and/or baseline mode shapes, or the natural frequencies and/or mode shapes of the other intentionally mistuned blade.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

A turbine engine, such as a gas turbine engine, generally includes a fan and a turbo-engine arranged in flow communication with one another with the core disposed downstream of the fan in the direction of flow through the turbine engine. The core of the turbine engine generally includes, in serial flow order, a compressor section, a combustion section, a turbine section, and an exhaust section. With multi-shaft gas turbine engines, the compressor section can include a high-pressure compressor (HPC) disposed downstream of a low-pressure compressor (LPC), and the turbine section can similarly include a low-pressure turbine (LPT) disposed downstream of a high-pressure turbine (HPT). With such a configuration, the HPC is coupled with the HPT via a high-pressure shaft (HPS), and the LPC is coupled with the LPT via a low-pressure shaft (LPS). Various sections of the turbine engine including the fan, the HPC, the LPC, the HPT, and the LPT include rotors and a plurality of blades coupled to the rotors.

A turbine engine includes a parameter (“AN²”) that is equal to the product of the annulus mid-area along the rotor blade (A) and the blade rotational speed squared (N²). Current engine designs strive for a greater AN² value. A greater AN² value indicates larger rotor blades and greater power output. A greater AN² value coupled with a slim airfoil design can, however, introduce rotor instability including flutter. Flutter can occur in both stationary airfoils (e.g., vanes) or rotating airfoils (e.g., blades) of a fan, a booster, a compressor, or a turbine of the turbine engine. Flutter is the self-excited vibration of the blades due to the interaction of structural-dynamic forces and aerodynamic forces. Flutter can lead to high-cycle fatigue (HCF) in the blade or even blade loss. Phase differences between the blades when the blades are vibrating can generate flutter. For example, if the blades are identical, the aeroelastic modes (coupled structural and aerodynamic system) are patterns of blade vibration having a constant phase angle between adjacent blades. Each aeroelastic mode has a different inter-blade phase angle. The inter-blade phase angle affects the phase between the local unsteady fluid flow through the blades and local blade motion, which, in turn, affects the unsteady aerodynamic work done on the blades. Adverse phase angles can lead to positive work being performed on the blades that results in flutter. Flutter normally is associated with one of the mode shapes of the blades and normally occurs at a natural frequency of the blade and can produce sustained blade vibration.

Flutter can occur at subsonic speeds and at supersonic speeds based on flow conditions at the fan inlet. Subsonic flutter typically occurs at about fifty percent to about eighty percent of the operating corrected speed of the rotor. The corrected speed of the rotor is the altitude equivalent speed at sea level in ambient conditions. When the turbine engine operates in the subsonic flutter corrected speed range and/or in the supersonic flutter corrected speed range, a shock, also referred to as a loading shock, is generated on the suction side of the blades and relatively close to the leading edge (LE) of the blades. For example, the shock may be generated at about twenty percent to thirty percent from the LE of the blades. The shock may cause the blades to vibrate due to the random forces available in the system at harmless amplitudes. As the blades vibrate, the shock generates perturbed unsteady pressure and generates the aerodynamic work, as detailed above. Positive energy may be added to the blade and results in vibration of the blade with a greater amplitude, which may cause a self-excited vibration. The shock (e.g., the unsteady pressure) may propagate circumferentially around the rotor and may propagate upstream and/or downstream of the blades. The various embodiments described herein, and shown in the figures, are directed to mitigating flutter risks in engines.

Intentional mistuning is a method often used to mitigate uncontrolled vibration amplification due to random uncontrolled mistuning by introducing a pattern that is more dominant than random mistuning. In one embodiment, intentional mistuning can be introduced by generating a frequency difference between blades in a row. The frequency difference is created by changing airfoil geometry by modifying a tip of the blade. The process of modifying the tip of the blade is referred to as “squealer tip change.” Using squealer tip depth as a geometry modifying parameter provides many benefits including ease of configuration as well as provides less impact on manufacturing in a final machining operation. In addition, changes to forging dies for manufacturing the blades may not be needed as the configuration of the blade is modified by removing material from the tip of the blades. Mode frequencies of models having various squealer tip depths are compared. For example, in an embodiment, the mode frequencies comparison shows that the level of changes to the tip of the airfoil may create frequency differences.

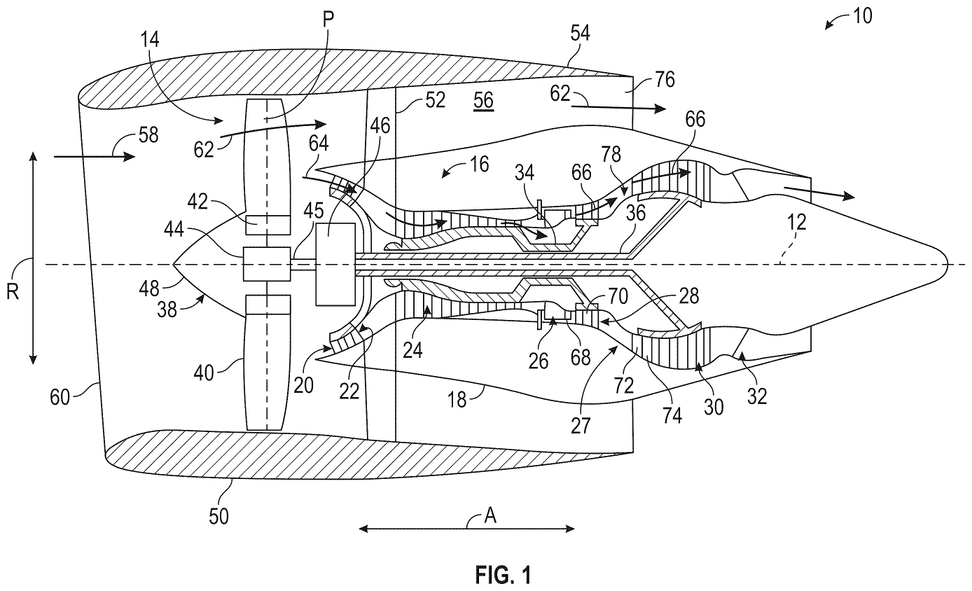

Referring now to the drawings, FIG. 1 is a schematic cross-sectional diagram of a turbine engine 10, according to an embodiment of the present disclosure. As shown in FIG. 1, the turbine engine 10 defines an axial direction A (extending parallel to a longitudinal centerline axis 12 provided for reference) and a radial direction R that is normal to the axial direction A. In general, the turbine engine 10 includes a fan section 14 and a turbo-engine 16 disposed downstream from the fan section 14.

The turbo-engine 16 depicted generally includes an outer casing 18 that is substantially tubular and defines an annular inlet 20. As schematically shown in FIG. 1, the outer casing 18 encases, in serial flow relationship, a compressor section 21 including a booster or a low pressure (LP) compressor 22 followed downstream by a high pressure (HP) compressor 24, a combustion section 26, a turbine section 27 including a high pressure (HP) turbine 28 followed downstream by a low pressure (LP) turbine 30, and a jet exhaust nozzle section 32. A high pressure (HP) shaft or a spool 34 drivingly connects the HP turbine 28 to the HP compressor 24 to rotate the HP turbine 28 and the HP compressor in unison. A low pressure (LP) shaft 36 drivingly connects the LP turbine 30 to the LP compressor 22 to rotate the LP turbine 30 and the LP compressor 22 in unison. The compressor section 21, the combustion section 26, the turbine section 27, and the jet exhaust nozzle section 32 together define a core air flowpath.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline 12 via a fan shaft 45 that is powered by the LP shaft 36 across a power gearbox 46. The power gearbox 46 includes a plurality of gears for adjusting the rotational speed of the fan shaft 45 and, thus, the fan 38 relative to the LP shaft 36 to a more efficient rotational fan speed.

Referring still to the exemplary embodiment of FIG. 1, the disk 42 is covered by a rotatable fan hub 48 aerodynamically contoured to promote an airflow through the plurality of fan blades 40. In addition, the fan section 14 includes an annular fan casing or a nacelle 50 that circumferentially surrounds the fan 38 and/or at least a portion of the turbo-engine 16. The nacelle 50 is supported relative to the turbo-engine 16 by a plurality of circumferentially spaced outlet guide vanes 52. Moreover, a downstream section 54 of the nacelle 50 extends over an outer portion of the turbo-engine 16 to define a bypass airflow passage 56 therebetween.

During operation of the turbine engine 10, a volume of air 58 enters the turbine engine 10 through an inlet 60 of the nacelle 50 and/or the fan section 14. As the volume of air 58 passes across the fan blades 40, a first portion of air 62 is directed or routed into the bypass airflow passage 56, and a second portion of air 64 is directed or is routed into the upstream section of the core air flowpath, or, more specifically, into the annular inlet 20 of the LP compressor 22. The ratio between the first portion of air 62 and the second portion of air 64 is commonly known as a bypass ratio. The pressure of the second portion of air 64 is then increased as it is routed through the HP compressor 24 and into the combustion section 26, where the highly pressurized air is mixed with fuel and burned to provide combustion gases 66.

The combustion gases 66 are routed into the HP turbine 28 and expanded through the HP turbine 28 where a portion of thermal and/or of kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or the spool 34 to rotate, thereby supporting operation of the HP compressor 24. The combustion gases 66 are then routed into the LP turbine 30 and expanded through the LP turbine 30. Here, a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus, causing the LP shaft 36 to rotate. This, thereby, supports operation of the LP compressor 22 and rotation of the fan 38 via the power gearbox 46.

The combustion gases 66 are subsequently routed through the jet exhaust nozzle section 32 of the turbo-engine 16 to provide propulsive thrust. Simultaneously, the pressure of the first portion of air 62 is substantially increased as the first portion of air 62 is routed through the bypass airflow passage 56 before being exhausted from a fan nozzle exhaust section 76 of the turbine engine 10, also providing propulsive thrust. The HP turbine 28, the LP turbine 30, and the jet exhaust nozzle section 32 at least partially define a hot gas path 78 for routing the combustion gases 66 through the turbo-engine 16.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable gas turbine engine, such as, for example, turbofan engines, propfan engines, turbojet engines, and/or turboshaft engines.

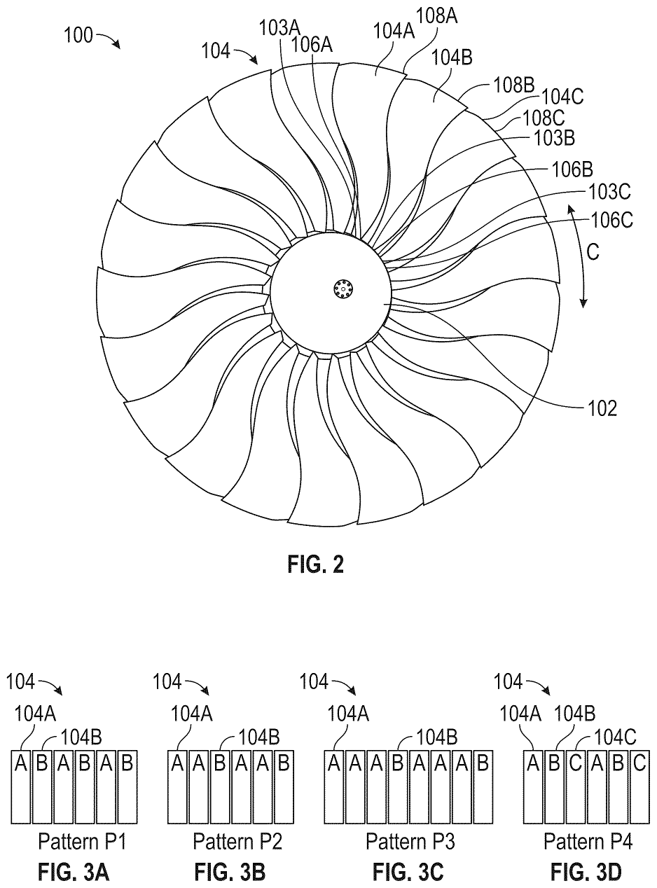

FIG. 2 is a schematic diagram of a front view of a rotor blade system 100 having a rotor 102 and a plurality of blades 104 mounted thereon, according to an embodiment of the present disclosure. The rotor blade system 100 depicted herein is the fan 38 (FIG. 1), the plurality of blades 104 are the fan blades 40 (FIG. 1), and the rotor 102 is the rotatable fan hub 48 (FIG. 1). In some examples, the rotor blade system 100 is used for the LP compressor 22 (FIG. 1) or the HP compressor 24 (FIG. 1). The rotor blade system 100 described herein, however, can be used in any system of the turbine engine 10 (FIG. 1). For example, the rotor blade system 100 described herein can be used in the LP turbine 30 (FIG. 1) and/or the HP turbine 28 (FIG. 1) of the turbine engine 10. The rotor blade system 100 is equally applicable to industrial gas turbines (IGTs) or power generation turbines. The present rotor blade system is not limited only to turbine engines, but can be used in any airfoil system (blade system) where the goal is to reduce flutter.

The rotor blade system 100 has the plurality of blades 104 mounted to the rotor 102. In some examples, the rotor 102 and the plurality of blades 104 form an integrated component, also referred to as a blisk. In some examples, the plurality of blades 104 are inserted into the rotor 102 such that the plurality of blades 104 and the rotor are separate components. In an embodiment, as illustrated in FIG. 2, the blades 104 can be equally spaced circumferentially around the circumference C of rotor 102. In another embodiment, however, the blades 104 may be unequally spaced circumferentially around the circumference C of the rotor 102. The plurality of blades 104 rotate with the rotation of the rotor 102. The plurality of blades 104 include baseline blades 104A and first intentionally mistuned blades 104B. In some examples, the plurality of blades 104 also includes second intentionally mistuned blades 104C, as detailed below.

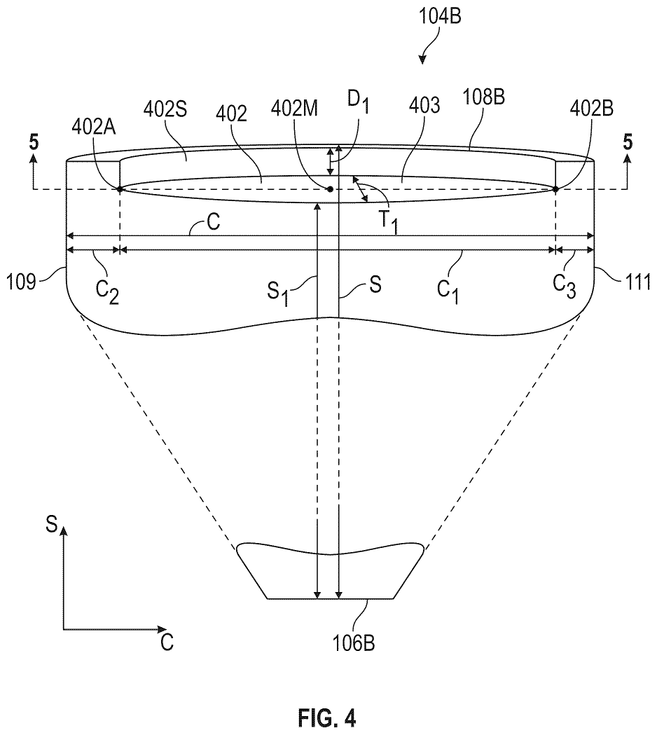

The baseline blades 104A are blades 104 that include a baseline shape, a baseline size, and/or baseline features. Thus, baseline blades 104A are blades 104 that do not include a mistuning feature. The first intentionally mistuned blades 104B and the second intentionally mistuned blades 104C are blades 104 having a mistuning feature 402 (shown in FIG. 4), as detailed further below. For example, the mistuning feature 402 changes the natural frequencies and/or the mode shapes of the intentionally mistuned blades with respect to the natural frequencies and/or the mode shapes of the baseline blades (e.g., the baseline natural frequencies and/or the baseline mode shapes) and/or of another intentionally mistuned blade. In this way, the first intentionally mistuned blades 104B and the second intentionally mistuned blades 104C provide for aerodynamic mistuning, natural frequency mistuning, and/or for mode shape mistuning relative to the baseline blades 104A, or relative to each other, to break self-excited fluid structure interactions, as detailed further below. This provides the ability to intentionally mistune the first intentionally mistuned blades 104B and the second intentionally mistuned blades 104C relative to the baseline blades 104A so as to control flutter, for example. The mistuning feature 402 (shown in FIG. 4) and the location of the mistuning feature 402 on a respective first intentionally mistuned blade 104B or a respective second intentionally mistuned blade 104C can be selected so that the natural frequency and/or the mode shape of the first intentionally mistuned blades 104B and the natural frequency and/or the mode shape of the second intentionally mistuned blades 104C can be mistuned relative to the baseline natural frequency and/or the baseline mode shape of the baseline blades 104A so as to control and to mitigate flutter. The mistuning feature 402 can be selected from one or more mistuning features, as detailed further below, to break self-excited fluid structure interaction.

The baseline blades 104A extend from a base 106A to a tip 108A of the baseline blades 104A. The base 106A is coupled to a platform 103A and the platform 103A is mounted to the rotor 102. Similarly, the first intentionally mistuned blades 104B extend from a base 106B to a tip 108B of the first intentionally mistuned blades 104B. The base 106B is coupled to a platform 103B and the platform 103B is mounted to the rotor 102. The second intentionally mistuned blades 104C extend from a base 106C to a tip 108C of the second intentionally mistuned blades 104C. The base 106C is coupled to a platform 103C and the platform 103C is mounted to the rotor 102.

FIGS. 3A through 3D show examples of patterns of blades 104, according to embodiments of the present disclosure. In an embodiment, a number and a pattern of the baseline blades 104A and first intentionally mistuned blades 104B can be varied to allow for natural frequency and/or mode shape tuning flexibility. For example, the pattern includes an airfoil distribution pattern of first intentionally mistuned blades 104B for flutter mitigation. The airfoil distribution pattern includes a circumferential distribution of baseline blades 104A and first intentionally mistuned blades 104B on the rotor 102.

The embodiments of FIGS. 3A through 3D are directed to an alternating pattern of baseline blades and intentionally mistuned blades. In this way, the intentionally mistuned blades break the self-excited fluid structure interactions. Therefore, embodiments of the present disclosure can be directed to mitigating flutter risks of turbofan engines. The present disclosure, however, may be directed to mitigating flutter risks for any type of turbine engine. Embodiments of the present disclosure seek to provide a way to intentionally mistune the blades so as to passively control flutter. For example, the embodiments described herein increase a flutter margin of the intentionally mistuned blades.

In the embodiment of FIG. 3A, the airfoil distribution pattern includes a first pattern P1. The first pattern P1 includes an “ABAB” pattern where “A” is a baseline blade 104A and “B” is a first intentionally mistuned blade 104B with a mistuning feature. The embodiment of FIG. 3A includes an alternating arrangement of baseline blades 104A and first intentionally mistuned blades 104B. As detailed below, the first intentionally mistuned blades 104B are mistuned from the baseline blades 104A to break the self-excited fluid structure interactions. The first intentionally mistuned blades 104B may include a reduced aerodynamic performance as compared to the baseline blades 104A in order to achieve the intentionally mistuning. The “ABAB” pattern allows for a balance between separating the natural frequencies and/or the mode shapes between the baseline blades 104A and the first intentionally mistuned blades 104B, and aerodynamic performance of the rotor blade system 100.

In the embodiment of FIG. 3B, the airfoil distribution pattern includes a second pattern P2. The second pattern P2 includes an “AABAAB” pattern in which one first intentionally mistuned blade 104B is disposed between two consecutive baseline blades 104A. The “AABAAB” pattern provides for increased aerodynamic performance, but reduced flutter mitigation, as compared to the “ABAB” pattern. For example, the more baseline blades 104A there are, the more aerodynamic performance of the rotor blade system 100. The fewer first intentionally mistuned blades 104B there are, however, the less mechanical damping is provided to mitigate the flutter.

In the embodiment of FIG. 3C, the airfoil distribution pattern includes a third pattern P3. The third pattern P3 includes an “AAABAAAB” pattern in which one first intentionally mistuned blade 104B is disposed between three consecutive baseline blades 104A. The “AAABAAAB” pattern provides for increased aerodynamic performance, but reduced flutter mitigation, as compared to the “ABAB” pattern and to the “AABAAB” pattern.

In the embodiment of FIG. 3D, the airfoil distribution pattern includes a fourth pattern P4. The fourth pattern P4 includes an “ABC” pattern where “B” is a first intentionally mistuned blade 104B having a first mistuning feature, and “C” is a second intentionally mistuned blade 104C having a second mistuning feature that is different than the first mistuning feature (e.g., a different mistuning feature and/or a different location of the mistuning feature on the second intentionally mistuned blade 104C as compared to the first intentionally mistuned blade 104B). For example, the “ABC” pattern provides for increased flutter mitigation as compared to the first airfoil distribution pattern P1, the second airfoil distribution pattern P2, and the third airfoil distribution pattern P3. In addition, the second intentionally mistuned blade 104C provides for an additional degree of freedom to improve tuning of the pattern of blades to a specific flutter mode. In some examples, other patterns of the airfoil distribution pattern may include second intentionally mistuned blades 104C (e.g., in an “AABC” pattern, in an “AABBC” pattern, in an “ABCC” pattern, or the like). The airfoil distribution pattern is selected from the group consisting of P1, P2, P3, P4, or a combination thereof. For example, the airfoil distribution pattern is selected from the group consisting of repeating patterns of AB, AAB, AAAB, ABC, AABC, AABBC, ABCC, or combinations thereof.

When developing a gas turbine engine, the interplay among components can make it particularly difficult to select or to develop one component during engine design and prototype testing, especially, when some components are at different stages of completion. For example, one or more components may be nearly complete, yet one or more other components may be in an initial or a preliminary phase such that only one (or a few) design parameters are known. We desire to arrive at design possibilities at an early stage of design, so that the downstream selection of candidate improved designs, given the tradeoffs, become more predictable. Heretofore, the process has sometimes been more ad hoc, selecting one design or another without knowing the impact when a concept is first taken into consideration. For example, and referring to FIG. 1, various aspects of the fan section 14 design (e.g., fan 38 design, the fan blades 40 design, etc.), the combustion section 26 design, the compressor section 21 design, the turbine section 27 design, etc., may not be known, but such components impact the aerodynamic performance of the engine and, thus, may influence the design of the fan blades 40.

We desire to narrow the range of configurations or combination of features that can yield favorable results given the constraints of the design, feasibility, manufacturing, certification requirements, for example, to arrive at a more favorable balance between mitigating flutter and improved aerodynamic performance, i.e., improved efficiency in the conversion of kinetic energy in the fluid stream to mechanical energy in the turbine shaft. We also desire to make selections earlier in a design selection process to avoid wasted time and effort. During the course of the evaluation of different embodiments as set forth herein, we, the inventors, discovered, unexpectedly, that there exists a relationship between the pattern of mistuning and the mistuning feature of the respective blades that uniquely identify a finite and readily ascertainable (in view of this disclosure) number of advantageous embodiments suitable for a particular architecture that addresses the flutter and the unsteady pressure experienced by the fan blades.

The airfoil distribution pattern (e.g., any of the patterns described in FIGS. 3A to 3D) can be selected based on improved flutter mitigation without impacting aerodynamic performance of the rotor blade system 100. For example, the first intentionally mistuned blades 104B break up the self-excited fluid structure interactions without impacting aerodynamic performance.

FIG. 4 is a schematic representation of the first intentionally mistuned blade 104B, according to embodiments of the present disclosure. While reference is made to the first intentionally mistuned blades 104B, the embodiments described herein may be applicable to the second intentionally mistuned blades 104C. As shown in FIG. 4, the first intentionally mistuned blade 104B is defined by a span in a spanwise direction S and a chord C in a chordwise direction. The span of the first intentionally mistuned blade 104B is defined from the base 106B to the tip 108B. The chord C of the first intentionally mistuned blade 104B is defined from a leading edge 109 (LE) of the first intentionally mistuned blade 104B to a trailing edge 111 (TE) of the first intentionally mistuned blade 104B. In some examples, the chord C of the first intentionally mistuned blade 104B varies along the span of the first intentionally mistuned blade 104B.

In the embodiment of FIG. 4, the first intentionally mistuned blade 104B includes a mistuning feature 402. Intentional mistuning is achieved by one or more mistuning features, as detailed further below, for natural frequency mistuning and/or for mode shape mistuning of the first intentionally mistuned blade 104B relative to the baseline natural frequencies and/or the baseline mode shapes of the baseline blade 104A (shown in FIG. 2). For example, the mistuning feature 402 may control the vibration frequencies and/or the mode shapes of the first intentionally mistuned blade 104B relative to the baseline natural vibration frequencies and/or the baseline mode shapes of the baseline blade 104A (FIG. 2).

The mistuning feature 402 may be located on the first intentionally mistuned blade 104B at a spanwise location S1. For example, the spanwise location S1 of the mistuning feature 402 can be measured from the base 106B of the first intentionally mistuned blade 104B to an edge of the mistuning feature 402 at about a mid-point 402M of the mistuning feature 402. The location of the mistuning feature 402 can also be measured by a depth dimension D₁ measured from the tip 108B of the first intentionally mistuned blade 104B to the edge of the mistuning feature 402 at about the mid-point 402M of the mistuning feature 402. For example, the depth dimension D₁ measured from the tip 108B to the edge of the mistuning feature 402 can be from 0% to 40% of a total span S from the tip 108B to the base 106B of the first intentionally mistuned blade 104B. A ratio of D₁/S is between 0% and 40%.

Therefore, the location of the mistuning feature 402 on the first intentionally mistuned blade 104B is defined by the depth dimension D₁ in the radial direction. The depth dimension D₁ is a percent of the span S of the first intentionally mistuned blade 104B. The location of the mistuning feature 402 on the first intentionally mistuned blade 104B is also defined by a width dimension C₁ in a direction of the chord C of the first intentionally mistuned blade 104B. The width dimension C₁ is a percentage of the chord C of the first intentionally mistuned blade 104B.

In one embodiment, a first end 402A of the mistuning feature 402 is located at a first distance C₂ from the leading edge 109 (LE) of the first intentionally mistuned blade 104B and a second end 402B of the mistuning feature 402 is located at second distance C₃ from the trailing edge 111 (TE) of the first intentionally mistuned blade 104B. In an embodiment, the mistuning width dimension C₁ can be centered within the chord C of the first intentionally mistuned blade 104B such that, for example, the first distance C₂ of the first end 402A of the mistuning feature 402 relative to the leading edge 109 is substantially equal to the second distance C3 of the second end 402B of the mistuning feature 402 relative to the trailing edge 111.

In an embodiment, the mistuning feature 402 has a thickness dimension T₁. The thickness dimension T₁ is perpendicular to a surface 402S of the first intentionally mistuned blade 104B. In an embodiment, the thickness dimension T₁ of the mistuning feature 402 corresponds to material removed from the first intentionally mistuned blade 104B. Therefore, in this embodiment, the mistuning feature 402 includes a notch 403 formed by removing or carving out material from the first intentionally mistuned blade 104B. The mistuning feature 402 is located at the vicinity of the tip 108B of the first intentionally mistuned blade 104B. In an embodiment, the thickness dimension T₁ of the mistuning feature 402 can be from 0% to 40% of a full thickness T (FIG. 6) of the first intentionally mistuned blade 104B. The full thickness T is measured from a surface of the first intentionally mistuned blade 104B to an opposite surface of the first intentionally mistuned blade 104B. In an embodiment, a ratio of T₁/T is from 0% to 40%.

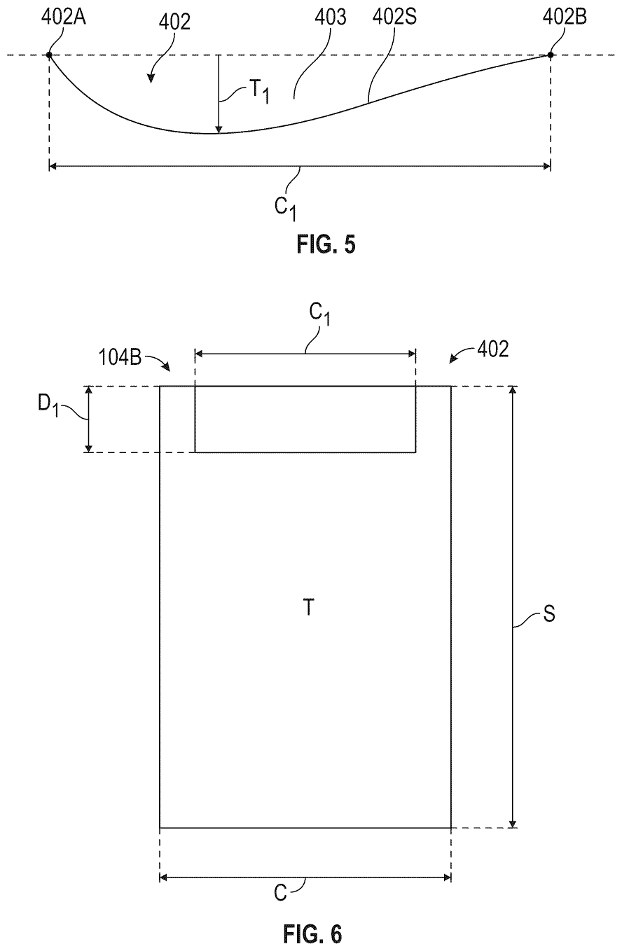

FIG. 5 is a cross section of the mistuning feature 402 (including the notch 403), taken along line 5-5 shown in FIG. 4, according to an embodiment of the present disclosure. FIG. 5 shows a profile of the thickness dimension T₁ along the width dimension C₁. In an embodiment, the thickness dimension T₁ can be substantially constant along the width dimension C₁. However, in another embodiment, as shown in FIG. 5, the thickness dimension T₁ varies along the width dimension C₁. Therefore, the mistuning feature 402 can have a thickness dimension profile. The profile of the thickness dimension T₁ versus the width dimension C₁ can be sloped, curved (as shown in FIG. 5), zigzagged, wavy, or any combination thereof, or any other desired shape.

The type of mistuning feature 402 and the location of the mistuning feature 402 on the first intentionally mistuned blade 104B are selected to change the natural frequency or the natural frequencies and/or associated mode shape(s) of the first intentionally mistuned blade 104B relative to baseline natural frequencies and/or baseline mode shapes of the baseline blades 104A.

For example, removing mass or material (e.g., carving out material to form the mistuning feature 402 or the notch 403) of the first intentionally mistuned blade 104B changes the natural frequencies of the first intentionally mistuned blade 104B relative to the baseline natural frequencies of the baseline blade 104A. Changing a location, such as the depth dimension D₁ in the spanwise direction, and/or changing the width dimension C₁ in the chord direction of the mistuning feature 402 on the first intentionally mistuned blade 104B, changes the natural frequencies and/or the mode shapes of the first intentionally mistuned blade 104B relative to the baseline natural frequencies and/or the baseline mode shapes of the baseline blade 104A. In an embodiment, the width dimension C₁ is about 0% to 85% (e.g., 40% to 60%) of the chord C of the first intentionally mistuned blade 104B. The chord C of first intentionally mistuned blade 104B is equal to the sum of the width dimension C₁, the first distance C₂, and the second distance C3 (i.e., C=C₁+C₂+C₃). A ratio of C₁/C is between 0% and 85%.

In an embodiment, in the order of frequency tuning sensitivity, the depth dimension D₁ can be the first or master controlling parameter for adjusting the vibration frequency of the first intentionally mistuned blade 104B. The second controlling parameter for adjusting the vibration frequency of the first intentionally mistuned blade 104B can be the thickness T₁. The third controlling parameter for adjusting the vibration frequency of the first intentionally mistuned blade 104B can be the width dimension C₁.

Intentional mistuning is often used to mitigate uncontrolled vibration amplification due to random uncontrolled mistuning by introducing a pattern that is more dominant than random mistuning. In one embodiment, intentional mistuning can be introduced by generating a vibration frequency difference between the first intentionally mistuned blade and baseline blades. The frequency difference is created by changing airfoil geometry by modifying the tip of the blade. The process of modifying the tip of the blade is referred to as “squealer tip change.” Using squealer tip depth as a geometry modifying parameter provides many benefits including ease of configuration as well as provides less impact on manufacturing in a final machining operation. In addition, changes to forging dies for manufacturing the blades may not be needed as the configuration of the blades is modified by removing material from the tip of the blades. Mode frequencies of models having various squealer tip depths are compared.

FIG. 6 is a schematic representation of the first intentionally mistuned blade 104B to show various dimensions of the mistuning feature 402 and various dimensions of the first intentionally mistuned blade 104B, according to an embodiment of the present disclosure. The parametric relationship between geometric characteristics of the mistuning feature 402 is determined such that the mistuning feature 402 generates at least 1% frequency difference from the nominal natural frequency of the blade without the mistuning feature 402. In other words, a ratio Ra of natural frequency W_{sq} of the blade with the mistuning feature 402 to the frequency W of the blade without the mistuning feature 402 is greater than or equal to 1.01 (i.e., W_{sq}/W≥1.01). This ratio R can be expressed by the following expression.

$$Ra = \frac{\sqrt{\frac{k}{{m}_{sq}}}}{\sqrt{\frac{k}{m}}} \geq 1.01 \qquad ( 1 )$$

$$where mass m = ρ SCT , and mass {m}_{sq} = ρ ( SCT - {C}_{1} {D}_{1} {T}_{1} ) \qquad ( 2 )$$

where S is an average span dimension of the intentionally mistuned blade 104B, C is an average chord dimension of the intentionally mistuned blade 104B, T is an average thickness dimension of the intentionally mistuned blade 104B, C₁ is an average chord dimension of the mistuning feature 402, T₁ is an average thickness dimension of the mistuning feature 402, D₁ is a depth dimension of the mistuning feature 402, ρ is a density of a material of the intentionally mistuned blade 104B, k is a stiffness of the intentionally mistuned blade 104B.

By replacing the mass m and mass m_{sq} in expression (1) with respective expressions (2), removing the square root, and simplifying, expression (3) is obtained.

$${Ra}^{2} = \frac{SCT}{SCT - {C}_{1} {D}_{1} {T}_{1}} \geq 1.020 \qquad ( 3 )$$

In other words, a ratio of a first product of an average span dimension, an average chord dimension and an average thickness dimension to a difference between the first product and a second product of an average chord dimension of the mistuning feature, the average thickness dimension of the mistuning feature and the depth dimension of the mistuning feature is greater than or equal to approximately 1.02.

Therefore, the ratio Ra can be adjusted by selecting appropriate values for the variables in expression (3) including the average thickness dimension T₁ of the mistuning feature 402, the depth D₁ of the mistuning feature 402, and the average chord dimension C₁ of the mistuning feature 402.

Although the first intentionally mistuned blade 104B (FIG. 4) and the first intentionally mistuned blade 105B (FIG. 6) are described above as being a rotor blade, the use of the first intentionally mistuned blade 104B or the first intentionally mistuned blade 105B is not limited to rotor blades only, but can also be used in stator blades or any airfoil where mitigation of uncontrolled vibration amplification may be needed.

Table 1 lists various values for the variables used in the mistuned blade 104B. The ratio Ra² is calculated using expression (3) taking as inputs various example set values, in examples 1 through 8, listed in Table 1. For each example, in examples 1 through 8, Ra² is calculated using a given set of values of the input variables S, C, C₁, D₁, T, and T₁. As shown in Table 1, the ratio Ra² is between 1.020 and 1.081 which satisfies the inequality Ra²≥1.020.

TABLE 1

| | | | | | | T1 (removed | |
|---|---|---|---|---|---|---|---|
| Example | S | C | C₁ | D₁ | T | material) or tsq | Ra² |
| 1 | 1.8 | 1.42 | 0.07 | 0.9 | 0.052 | 0.0416 | 1.0204 |
| 2 | 1.8 | 1.42 | 1.35 | 0.9 | 0.052 | 0.0026 | 1.0243 |
| 3 | 2.4 | 1.6 | 1.35 | 0.4 | 0.075 | 0.04 | 1.0811 |
| 4 | 3.2 | 2.2 | 1.2 | 0.7 | 0.09 | 0.016 | 1.0217 |
| 5 | 3.2 | 2.2 | 1.86 | 0.11 | 0.09 | 0.065 | 1.0214 |
| 6 | 3.2 | 2.2 | 0.8 | 0.96 | 0.09 | 0.035 | 1.0443 |
| 7 | 1.8 | 1.42 | 0.2 | 0.7 | 0.052 | 0.02 | 1.0215 |
| 8 | 1.8 | 1.42 | 1.21 | 0.5 | 0.052 | 0.005 | 1.0233 |

Based on the values provided in Table 1, various ratios are also calculated. Table 2 lists the ratios calculated using the values of the examples 1 through 8. Based on the calculated ratios, ranges of the ratios are determined. For example, the calculated range of the ratio D₁/S is between 3% and 50%, the range of the ratio T₁/T is between 5% and 80%, and the range of the ratio C₁/C is between 5% and 95%.

TABLE 2

| Example | D₁/S | T₁/T | C₁/C |
|---|---|---|---|
| 1 | 0.50 | 0.80 | 0.05 |
| 2 | 0.50 | 0.05 | 0.95 |
| 3 | 0.17 | 0.53 | 0.84 |
| 4 | 0.22 | 0.18 | 0.55 |
| 5 | 0.03 | 0.72 | 0.85 |
| 6 | 0.30 | 0.39 | 0.36 |
| 7 | 0.39 | 0.38 | 0.14 |
| 8 | 0.28 | 0.10 | 0.85 |
| Calculated | 3% to 50% | 5% to 80% | 5% to 95% |
| Ranges | | | |

Further aspects are provided by the subject matter of the following clauses.

A rotor blade system including a rotor, and a plurality of blades coupled to the rotor, the plurality of blades arranged in an airfoil distribution pattern, the airfoil distribution pattern comprising one or more baseline blades and one or more intentionally mistuned blades. The one or more intentionally mistuned blades have a span from a base of the one or more intentionally mistuned blades to a tip of the one or more intentionally mistuned blades and a chord defined from a leading edge of the one or more intentionally mistuned blades to a trailing edge of the one or more intentionally mistuned blades. The one or more intentionally mistuned blades includes a mistuning feature, the mistuning feature including a notch formed on a surface of the one or more intentionally mistuned blades, the mistuning feature being located at a vicinity of the tip of the one or more intentionally mistuned blade to generate a vibration frequency difference between a vibration frequency of the one or more intentionally mistuned blades and a baseline natural vibration frequency of the one or more baseline blades.

The rotor blade system of the preceding clause, wherein the mistuning feature is located at a depth dimension measured from the tip of the one or more intentionally mistuned blades to a mid-point of the mistuning feature.

The rotor blade system of any preceding clause, wherein the mistuning feature is defined by a width dimension in a direction of the chord of the one or more intentionally mistuned blades.

The rotor blade system of any preceding clause, wherein the mistuning feature is defined by a thickness dimension in a direction substantially perpendicular to the surface of the one or more intentionally mistuned blades, the thickness dimension corresponding to material removed from the surface of the one or more intentionally mistuned blades to form the notch.

The rotor blade system of any preceding clause, wherein the thickness dimension of the mistuning feature is substantially constant along the width dimension of the mistuning feature.

The rotor blade system of any preceding clause, wherein the thickness dimension is variable along the width dimension of the mistuning feature such that the mistuning feature has a thickness dimension profile versus the width dimension that is sloped, curved, zigzagged, wavy, or any other selected shape, the thickness dimension profile being selected to generate the vibration frequency difference between the vibration frequency of the one or more intentionally mistuned blades and the baseline natural vibration frequency of the one or more baseline blades.

The rotor blade system of any preceding clause, wherein a ratio of the depth dimension to the thickness dimension is selected such that the vibration frequency of the one or more intentionally mistuned blades is different from the baseline natural vibration frequency of the one or more baseline blades.

The rotor blade system of any preceding clause, wherein a ratio of the depth dimension to the thickness dimension is selected such that the vibration frequency difference between the vibration frequency of the one or more intentionally mistuned blades and the baseline natural vibration frequency of the one or more baseline blades is approximately 2% to 6% of the baseline natural vibration frequency of the one or more baseline blades.

The rotor blade system of any preceding clause, wherein a ratio of a first product of an average span dimension, an average chord dimension and an average thickness dimension to a difference between the first product and a second product of an average chord dimension of the mistuning feature, the average thickness dimension of the mistuning feature and the depth dimension of the mistuning feature is greater than or equal to approximately 1.02.

The rotor blade system of any preceding clause, wherein the one or more baseline blades do not include the mistuning feature.

The rotor blade system of any preceding clause, wherein the airfoil distribution pattern is selected from the group consisting of AB, AAB, AAAB, ABC, AABC, AABBC, ABCC, or any combination thereof, wherein A is a baseline blade, B is a first intentionally mistuned blade with a first mistuning feature, and C is a second intentionally mistuned blade with a second mistuning feature different than the first mistuning feature.

The rotor blade system of any preceding clause, wherein a parametric relationship between geometric characteristics of the mistuning feature is determined such that the mistuning feature generates at least 1% frequency difference from a nominal natural frequency of the blade without the mistuning feature.

The rotor blade system of any preceding clause, wherein a ratio of natural frequency of the intentionally mistuned blade with the mistuning feature to the nominal natural frequency of the blade without the mistuning feature is greater than or equal to 1.01.

A turbine engine includes a fan section, a compressor section, and a turbine section, wherein at least one of the fan section, the compressor section, or the turbine section includes a rotor blade system according to any preceding clause.

The turbine engine of the preceding clause, wherein the compressor section includes a low pressure compressor and a high pressure compressor, wherein at least one of the low pressure compressor or the high pressure compressor includes the rotor blade system.

The turbine engine of any preceding clause, wherein the turbine section includes a high pressure turbine and a low pressure turbine, wherein at least one of the high pressure turbine or the low pressure turbine includes the rotor blade system.

The turbine engine of any preceding clause, further including a high pressure shaft drivingly connecting the high pressure turbine to the high pressure compressor to rotate the high pressure turbine and the high pressure compressor in unison.

The turbine engine of any preceding clause, further including a low pressure shaft drivingly connecting the low pressure turbine to the low pressure compressor to rotate the low pressure turbine and the low pressure compressor in unison.

A turbine engine includes a fan section, a compressor section, and a turbine section. At least one of the fan section, the compressor section, and the turbine section includes a rotor blade system. The rotor blade system includes a rotor, and a plurality of blades coupled to the rotor, the plurality of blades arranged in an airfoil distribution pattern, the airfoil distribution pattern comprising one or more baseline blades and one or more intentionally mistuned blades. The one or more intentionally mistuned blades have a span from a base of the one or more intentionally mistuned blades to a tip of the one or more intentionally mistuned blades and a chord defined from a leading edge of the one or more intentionally mistuned blades to a trailing edge of the one or more intentionally mistuned blades. The one or more intentionally mistuned blades include a mistuning feature, the mistuning feature includes a notch formed on a surface of the one or more intentionally mistuned blades, the mistuning feature being located at a vicinity of the tip of the one or more intentionally mistuned blade to generate a vibration frequency difference between a vibration frequency of the one or more intentionally mistuned blades and a baseline natural vibration frequency of the one or more baseline blades.

The turbine engine of the preceding clause, wherein the mistuning feature is located at a depth dimension measured from the tip of the one or more intentionally mistuned blades to a mid-point of the mistuning feature.

The turbine engine of any preceding clause, wherein the mistuning feature is defined by a width dimension in a direction of the chord of the one or more intentionally mistuned blades.

The turbine engine of the preceding clause, wherein the mistuning feature is defined by a thickness dimension in a direction substantially perpendicular to the surface of the one or more intentionally mistuned blades, the thickness dimension corresponding to material removed from the surface of the one or more intentionally mistuned blades to form the notch.

The turbine engine of the preceding clause, wherein the thickness dimension of the mistuning feature is substantially constant along the width dimension of the mistuning feature.

The turbine engine of the preceding clause, wherein the thickness dimension is variable along the width dimension of the mistuning feature such that the mistuning feature has a thickness dimension profile versus the width dimension that is sloped, curved, zigzagged, wavy, or any other selected shape, the thickness dimension profile being selected to generate the vibration frequency difference between the vibration frequency of the one or more intentionally mistuned blades and the baseline natural vibration frequency of the one or more baseline blades.

The turbine engine of the preceding clause, wherein a ratio of the depth dimension to the thickness dimension is selected such that the vibration frequency of the one or more intentionally mistuned blades is different from the baseline natural vibration frequency of the one or more baseline blades.

The turbine engine of the preceding clause, wherein a ratio of a first product of an average span dimension, an average chord dimension and an average thickness dimension to a difference between the first product and a second product of an average chord dimension of the mistuning feature, the average thickness dimension of the mistuning feature and the depth dimension of the mistuning feature is greater than or equal to approximately 1.02.

The turbine engine of the preceding clause, wherein the one or more baseline blades do not include the mistuning feature.

The turbine engine of the preceding clause, wherein the airfoil distribution pattern is selected from the group consisting of AB, AAB, AAAB, ABC, AABC, AABBC, ABCC, or any combination thereof, wherein A is a baseline blade, B is a first intentionally mistuned blade with a first mistuning feature, and C is a second intentionally mistuned blade with a second mistuning feature different than the first mistuning feature.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A rotor blade system for a turbine engine, the rotor blade system comprising:
a rotor; and
a plurality of blades coupled to the rotor, the plurality of blades arranged in an airfoil distribution pattern, the airfoil distribution pattern comprising one or more baseline blades and one or more intentionally mistuned blades,
wherein the one or more intentionally mistuned blades have a span from a base of the one or more intentionally mistuned blades to a tip of the one or more intentionally mistuned blades and a chord defined from a leading edge of the one or more intentionally mistuned blades to a trailing edge of the one or more intentionally mistuned blades, and
wherein the one or more intentionally mistuned blades includes a mistuning feature, the mistuning feature includes a notch formed on a surface of the one or more intentionally mistuned blades, the mistuning feature being located at a vicinity of the tip of the one or more intentionally mistuned blades to generate a vibration frequency difference between a vibration frequency of the one or more intentionally mistuned blades and a baseline natural vibration frequency of the one or more baseline blades.

2. The rotor blade system of claim 1, wherein the one or more baseline blades do not include the mistuning feature.

3. The rotor blade system of claim 1, wherein the airfoil distribution pattern is selected from a group consisting of: AB, AAB, AAAB, ABC, AABC, AABBC, ABCC, or any combination thereof, wherein A is a baseline blade, B is a first intentionally mistuned blade with a first mistuning feature, and C is a second intentionally mistuned blade with a second mistuning feature different than the first mistuning feature.

4. The rotor blade system of claim 1, wherein the mistuning feature is located at a depth dimension measured from the tip of the one or more intentionally mistuned blades to a mid-point of the mistuning feature.

5. The rotor blade system of claim 4, wherein the mistuning feature is defined by a width dimension in a direction of the chord of the one or more intentionally mistuned blades.

6. The rotor blade system of claim 5, wherein the mistuning feature is defined by a thickness dimension in a direction substantially perpendicular to the surface of the one or more intentionally mistuned blades, the thickness dimension corresponding to material removed from the surface of the one or more intentionally mistuned blades to form the notch.

7. The rotor blade system of claim 6, wherein the thickness dimension of the mistuning feature is substantially constant along the width dimension of the mistuning feature.

8. The rotor blade system of claim 6, wherein the thickness dimension is variable along the width dimension of the mistuning feature such that the mistuning feature has a thickness dimension profile versus the width dimension that is sloped, curved, zigzagged, wavy, or any other selected shape, the thickness dimension profile being selected to generate the vibration frequency difference between the vibration frequency of the one or more intentionally mistuned blades and the baseline natural vibration frequency of the one or more baseline blades.

9. The rotor blade system of claim 6, wherein a ratio of the depth dimension to the thickness dimension is selected such that the vibration frequency of the one or more intentionally mistuned blades is different from the baseline natural vibration frequency of the one or more baseline blades.

10. The rotor blade system of claim 9, wherein a ratio of a first product of an average span dimension, an average chord dimension and an average thickness dimension to a difference between the first product and a second product of an average chord dimension of the mistuning feature, the average thickness dimension of the mistuning feature and the depth dimension of the mistuning feature is greater than or equal to approximately 1.02.

11. A turbine engine comprising:
a fan section;
a compressor section; and
a turbine section, wherein at least one of the fan section, the compressor section, or the turbine section includes a rotor blade system comprising:
a rotor; and
a plurality of blades coupled to the rotor, the plurality of blades arranged in an airfoil distribution pattern, the airfoil distribution pattern comprising one or more baseline blades and one or more intentionally mistuned blades,
wherein the one or more intentionally mistuned blades have a span from a base of the one or more intentionally mistuned blades to a tip of the one or more intentionally mistuned blades and a chord defined from a leading edge of the one or more intentionally mistuned blades to a trailing edge of the one or more intentionally mistuned blades, and
wherein the one or more intentionally mistuned blades includes a mistuning feature, the mistuning feature includes a notch formed on a surface of the one or more intentionally mistuned blades, the mistuning feature being located at a vicinity of the tip of the one or more intentionally mistuned blades to generate a vibration frequency difference between a vibration frequency of the one or more intentionally mistuned blades and a baseline natural vibration frequency of the one or more baseline blades.

12. The turbine engine of claim 11, wherein the one or more baseline blades do not include the mistuning feature.

13. The turbine engine of claim 11, wherein the airfoil distribution pattern is selected from a group consisting of: AB, AAB, AAAB, ABC, AABC, AABBC, ABCC, or any combination thereof, wherein A is a baseline blade, B is a first intentionally mistuned blade with a first mistuning feature, and C is a second intentionally mistuned blade with a second mistuning feature different than the first mistuning feature.

14. The turbine engine of claim 11, wherein the mistuning feature is located at a depth dimension measured from the tip of the one or more intentionally mistuned blades to a mid-point of the mistuning feature.

15. The turbine engine of claim 14, wherein the mistuning feature is defined by a width dimension in a direction of the chord of the one or more intentionally mistuned blades.

16. The turbine engine of claim 15, wherein the mistuning feature is defined by a thickness dimension in a direction substantially perpendicular to the surface of the one or more intentionally mistuned blades, the thickness dimension corresponding to material removed from the surface of the one or more intentionally mistuned blades to form the notch.

17. The turbine engine of claim 16, wherein the thickness dimension of the mistuning feature is substantially constant along the width dimension of the mistuning feature.

18. The turbine engine of claim 16, wherein the thickness dimension is variable along the width dimension of the mistuning feature such that the mistuning feature has a thickness dimension profile versus the width dimension that is sloped, curved, zigzagged, wavy, or any other selected shape, the thickness dimension profile being selected to generate the vibration frequency difference between the vibration frequency of the one or more intentionally mistuned blades and the baseline natural vibration frequency of the one or more baseline blades.

19. The turbine engine of claim 16, wherein a ratio of the depth dimension to the thickness dimension is selected such that the vibration frequency of the one or more intentionally mistuned blades is different from the baseline natural vibration frequency of the one or more baseline blades.

20. The turbine engine of claim 19, wherein a ratio of a first product of an average span dimension, an average chord dimension and an average thickness dimension to a difference between the first product and a second product of an average chord dimension of the mistuning feature, the average thickness dimension of the mistuning feature and the depth dimension of the mistuning feature is greater than or equal to approximately 1.02.
